(19) United States
(12) Patent Application Publication
(10) Pub. No.: US 2026/0005497 A1
(43) Pub. Date: Jan. 1, 2026

(54) IMPACT RELEASEABLE CABLE BUNDLER ROUTER

(71) Applicant: FCA US LLC, Auburn Hills, MI (US)

(72) Inventors: Milind S. Parab, Auburn Hills, MI (US); Robert Attisha, Auburn Hills, MI (US); Christopher Connolly, Auburn Hills, MI (US); Amal Hisham Edassery Shereef, Auburn Hills, MI (US); Richard J. Gosk, Auburn Hills, MI (US)

(21) Appl. No.: 18/754,337

(22) Filed: Jun. 26, 2024

(51) Int. Cl. H02G 3/04; B60L 50/60; B60R 16/02; H01M 50/249

(52) U.S. Cl. CPC H02G 3/0418; B60L 50/60; B60R 16/0215; H01M 50/249; H01M 2220/20

(57) ABSTRACT

An impact releasable cable bundle router for a vehicle electrical system includes a base plate configured to couple to a vehicle component, a cable support extending outwardly from the base plate and including a cable receiving surface configured to receive an electrical cable, and a cable cover configured to couple to the cable support to secure the electrical cable therebetween. The cable cover includes a fastener clip to at least partially secure the cable cover to the cable support. The fastener clip is configured to intentionally break away from the cable cover under a predetermined load from a vehicle impact event to thereby release the electrical cable and cable cover and facilitate preventing pull out loads on an electrical connector of the electrical cable.

### FIELD

The present application relates generally to high voltage battery systems for vehicles and, more particularly, to a high voltage cable bundle router with impact release features.

### BACKGROUND

Some vehicles, such as plug-in electric hybrid vehicles (PHEVs), include a high voltage (HV) battery system with HV cables connecting various system components. However, such system components may be subject to loading during impact events, which can potentially create high pullout forces on the HV cables. Therefore, while such systems do work well for their intended purpose, it is desirable to provide continuous improvement in the relevant art.

### SUMMARY

In accordance with one example aspect of the invention, an impact releasable cable bundle router for a vehicle electrical system is provided. In one example implementation, the cable bundle router includes a base plate configured to couple to a vehicle component, a cable support extending outwardly from the base plate and including a cable receiving surface configured to receive an electrical cable, and a cable cover configured to couple to the cable support to secure the electrical cable therebetween. The cable cover includes a fastener clip to at least partially secure the cable cover to the cable support. The fastener clip is configured to intentionally break away from the cable cover under a predetermined load from a vehicle impact event to thereby release the electrical cable and cable cover and facilitate preventing pull out loads on an electrical connector of the electrical cable.

In addition to the foregoing, the impact releasable cable bundle router may include one or more of the following features: wherein the cable receiving surface is a first rounded cable receiving surface configured to partially surround the electrical cable; wherein the cable cover includes a second rounded cable receiving surface configured to align with the first rounded cable receiving surface to surround the electrical cable; and wherein the fastener clip is a first fastener clip, and the cable cover further includes an intermediate tab and a second fastener clip.

In addition to the foregoing, the impact releasable cable bundle router may include one or more of the following features: wherein the cable support includes a first slot configured to receive the first fastener clip, an intermediate slot configured to receive the intermediate tab, and a second slot configured to receive the second fastener clip; wherein the intermediate tab is disposed between the first and second fastener clips; and wherein the intermediate slot is disposed between the first and second slots.

In addition to the foregoing, the impact releasable cable bundle router may include one or more of the following features: wherein the cable receiving surface includes a first cable receiving surface disposed between the first slot and the intermediate slot and configured to receive a first electrical cable, and a second cable receiving surface disposed between the intermediate slot and the second slot and configured to receive a second electrical cable; wherein the cable cover includes a semi-annular flange with a convex slot; and a tie strap disposed within the convex slot and extending about the electrical cable to secure the cable cover to the electrical cable to facilitate preventing separation therebetween when the cable cover is released from the cable support during the vehicle impact event.

In accordance with another example aspect of the invention, a vehicle is provided. In one example implementation, the vehicle includes an electric traction motor, a high voltage (HV) battery configured to provide power to the electric motor, a HV cable bundle including a HV cable electrically coupled to the HV battery, and an impact releasable HV cable bundle router configured to support the HV cable bundle in a desired orientation.

The HV cable bundle router includes a base plate configured to couple to a vehicle component, a cable support extending outwardly from the base plate and including a cable receiving surface configured to receive the HV cable, and a cable cover configured to couple to the cable support to secure the HV cable therebetween. The cable cover includes a fastener clip to at least partially secure the cable cover to the cable support. The fastener clip is configured to intentionally break away from the cable cover under a predetermined load from a vehicle impact event to thereby release the HV cable and cable cover to facilitate preventing pull out loads on an electrical connector of the HV cable.

In addition to the foregoing, the described vehicle may include one or more of the following features: wherein the cable receiving surface is a first rounded cable receiving surface configured to partially surround the HV cable; wherein the cable cover includes a second rounded cable receiving surface configured to align with the first rounded cable receiving surface to surround the HV cable; wherein the fastener clip is a first fastener clip, and the cable cover further includes an intermediate tab and a second fastener clip; and wherein the cable support includes a first slot configured to receive the first fastener clip, an intermediate slot configured to receive the intermediate tab, and a second slot configured to receive the second fastener clip.

In addition to the foregoing, the described vehicle may include one or more of the following features: wherein the intermediate tab is disposed between the first and second fastener clips; wherein the intermediate slot is disposed between the first and second slots; wherein the HV cable includes a first HV cable and a second HV cable, and wherein the cable receiving surface includes a first cable receiving surface disposed between the first slot and the intermediate slot and configured to receive a first HV cable, and a second cable receiving surface disposed between the intermediate slot and the second slot and configured to receive a second HV cable; wherein the cable cover includes a semi-annular flange with a convex slot; and a tie strap disposed within the convex slot and extending about the HV cable to secure the cable cover to the HV cable to facilitate preventing separation therebetween when the cable cover is released from the cable support during the vehicle impact event.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of an example high voltage battery system with an impact releasable cable bundle router, in accordance with the principles of the present application; and

FIG. 2 is an exploded view of a portion of the impact releasable cable bundle router shown in FIG. 1, in accordance with the principles of the present application.

### DESCRIPTION

According to the principles of the present application, systems and methods are described for a high voltage (HV) cable router configured to release one or more HV cables during a vehicle impact event. The HV cable router includes a base plate configured to couple to an integrated dual charging module (IDCM) and route HV cables between a battery pack and a HV power distribution module. A cover is secured to the HV cables and includes one or more tabs configured to be subsequently coupled to the base plate such that the HV cables are secured between the base plate and the cover.

During normal operation, the one or more tabs are configured to hold the HV cables in place. During an impact event where the battery pack is forced out of position, which causes tension on the HV cables, the one or more tabs are designed to fail, separate, or break away under a predetermined load to release the HV cables and reduce or prevent cable pull-out forces caused by the impact event. In one example, the predetermined load is less than a pullout force that causes the HV cables to be pulled out of their electrical connectors.

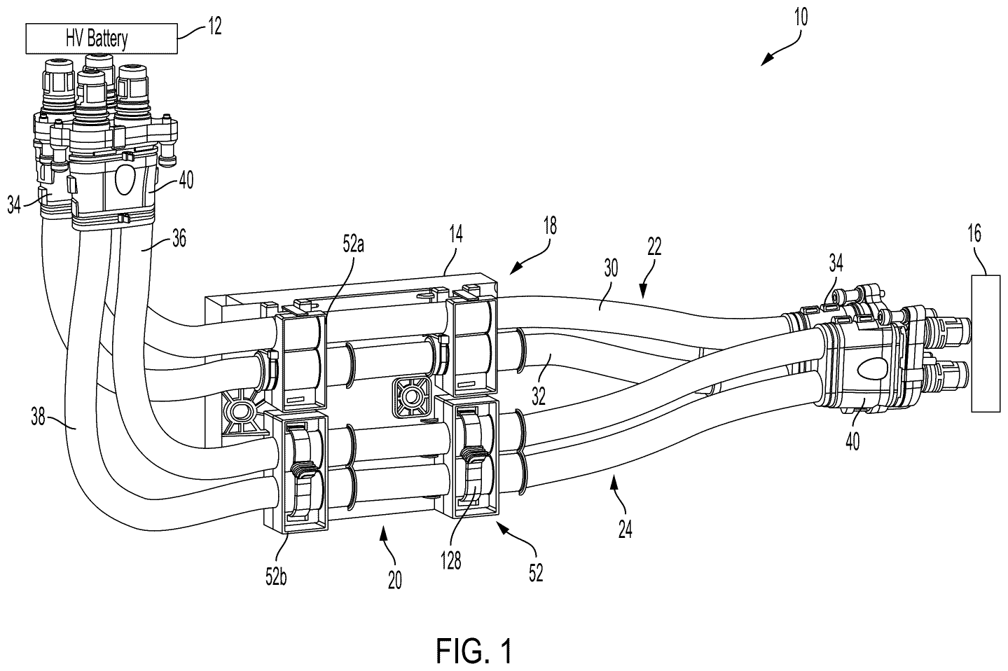

With initial reference to FIG. 1, a high voltage (HV) battery system 10 for an electric vehicle or hybrid electric vehicle is illustrated in accordance with the principles of the present disclosure. In the example embodiment, the HV battery system 10 includes a HV battery pack 12, a charging module 14 such as an integrated dual charging module (IDCM), a HV power distribution module 16, and an impact releasable HV cable bundle router assembly 18. The HV battery pack 12 is configured as a power source for a motor or generator (not shown) to provide propulsive power to the vehicle. The IDCM 14 is configured to support charging of the HV battery pack 12 from a wall charger or similar device. The HV power distribution module 16 is configured to distribute HV power to various components, such as the electric traction motor.

With continued reference to FIG. 1, the HV cable bundle router assembly 18 will be described in more detail. In the illustrated example, the HV cable bundle router assembly 18 generally includes an impact releasable HV cable bundle router 20, a first HV cable bundle 22, and a second HV cable bundle 24. The HV cable bundle router 20 is configured to couple to a vehicle component, such as IDCM 14, and secure and support the HV cable bundles 22, 24 in a desired orientation.

The first HV cable bundle 22 is electrically coupled between the HV battery pack 12 and the HV power distribution module 16 and includes a first HV cable 30 and a second HV cable 32. Each HV cable 30, 32 includes an electrical connector 34 disposed at opposite ends for coupling to the HV battery pack 12 or the HV power distribution module 16.

Similarly, the second HV cable bundle 24 is electrically coupled between the HV battery pack 12 and the HV power distribution module 16 and includes a first HV cable 36 and a second HV cable 38. Each HV cable 36, 38 includes an electrical connector 40 disposed at opposite ends for coupling to the HV battery pack 12 or the HV power distribution module 16.

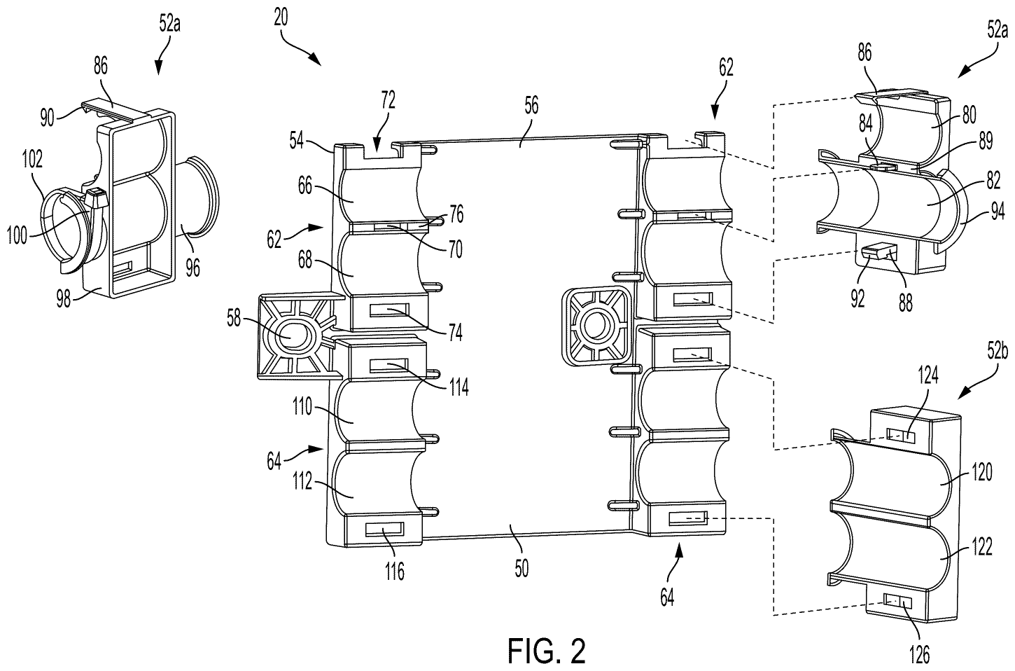

With additional reference to FIG. 2, the HV cable bundle router 20 generally includes a base plate 50 and a plurality of cable covers 52. The base plate 50 is a generally flat plate having a first side 54, an opposite second side 56, and one or more apertures 58 configured to receive a fastener (e.g., a bolt, not shown) for securing the HV cable bundle router 20 to a vehicle component, such as the IDCM 14. The first side 54 is configured to be positioned against the vehicle component (IDCM 14).

As shown in FIG. 1, a pair of upper cable supports 62 and a pair of lower cable supports 64 extend outwardly from the base plate second side 56. It will be appreciated that HV cable bundle router 20 may have any number of upper or lower cable supports 62 as necessary for a desired application. In the example embodiment, each upper cable support 62 includes a first rounded cable receiving surface 66 and a second rounded cable receiving surface 68. The first rounded cable receiving surface 66 is generally concave and configured to receive and partially surround the first HV cable 30, and the second rounded cable receiving surface 68 is generally concave and configured to receive and partially surround the second HV cable 32. However, the upper cable support 62 may include any desired number of rounded cable receiving surfaces to accommodate a desired number of HV cables.

In the example embodiment, each upper cable support 62 also includes an intermediate slot 70 disposed between a first outboard slot 72 and a second outboard slot 74. In this way, the first outboard slot 72 is disposed at one end of the first rounded cable receiving surface 66, the intermediate slot 70 is disposed along an edge 76 between the first and second rounded cable receiving surfaces 66, 68, and the second outboard slot 74 is disposed at one end of the second rounded cable receiving surface 68.

With continued reference to FIGS. 1 and 2, each upper cable support 62 is configured to receive an upper cable cover 52a to secure the HV cables 30, 32 therebetween, as shown in FIG. 1. In the example embodiment, each upper cable cover 52a includes a first rounded cable receiving surface 80 and a second rounded cable receiving surface 82. The first rounded cable receiving surface 80 is generally concave and configured to receive and partially surround the first HV cable 30, and the second rounded cable receiving surface 82 is generally concave and configured to receive and partially surround the second HV cable 32. It will be appreciated, however, that the upper cable cover 52a may include any desired number of rounded cable receiving surfaces to accommodate a desired number of HV cables.

In the example embodiment, each upper cable cover 52a also includes an intermediate tab 84 disposed between a first fastener clip 86 and a second fastener clip 88. In this way, the first fastener clip 86 is disposed at one end of the first rounded cable receiving surface 80, the intermediate tab 84 is disposed along an edge 89 between the first and second rounded cable receiving surfaces 80, 82, and the second fastener clip 88 is disposed at one end of the second rounded cable receiving surface 82.

As shown in FIG. 2, the first fastener clip 86 is configured to be received within first outboard slot 72 and secured therein via a detent 90. Further, the intermediate tab 84 is configured to be received within the intermediate slot 70, and the second fastener clip 88 is configured to be received within the second outboard slot 74 and secured therein via a detent 92. Additionally, as described herein in more detail, the first fastener clip 86 and/or the second fastener clip 88 are configured break at predefined impact/force loads to allow the upper cable cover 52a to separate from the upper cable support 62 and allow free movement of the HV cables to reduce pullout force on the HV cables during an impact event.

As shown in FIG. 2, the upper cable cover 52a also includes opposed semi-annular flanges 94 and 96 extending outwardly from an interior frame 98. The flanges 94 and 96 are configured to extend the second rounded cable receiving surface 82 beyond the interior frame 98. Further, flange 94 includes a convex or rounded slot 100 configured to receive a fastener 102 (e.g., a tie strap) to secure the upper cable cover 52a to the HV cables 30, 32.

With continued reference to FIG. 2, in the example embodiment, each lower cable support 64 includes a first rounded cable receiving surface 110 and a second rounded cable receiving surface 112. The first rounded cable receiving surface 110 is generally concave and configured to receive and partially surround the first HV cable 36, and the second rounded cable receiving surface 112 is generally concave and configured to receive and partially surround the second HV cable 38. It will be appreciated, however, that the lower cable support 64 may include any desired number of rounded cable receiving surfaces to accommodate a desired number of HV cables.

In the example embodiment, each lower cable support 64 also includes a pair of outboard slots 114, 116. The first outboard slot 114 is disposed at one end of the first rounded cable receiving surface 110, and the second outboard slot 74 is disposed at one end of the second rounded cable receiving surface 112, such that the first and second cable receiving surfaces 110, 112 are disposed between the outboard slots 114, 116.

With continued reference to FIGS. 1 and 2, each lower cable support 64 is configured to receive a lower cable cover 52b to secure the HV cables 36, 38 therebetween, as shown in FIG. 1. In the example embodiment, each lower cable cover 52b includes a first rounded cable receiving surface 120 and a second rounded cable receiving surface 122. The first rounded cable receiving surface 120 is generally concave and configured to receive and partially surround the first HV cable 36, and the second rounded cable receiving surface 122 is generally concave and configured to receive and partially surround the second HV cable 38. However, the lower cable cover 52b may include any desired number of rounded cable receiving surfaces to accommodate a desired number of HV cables.

In the example embodiment, each lower cable cover 52b also includes a pair of outboard slots 124, 126 configured to align with the pair of outboard slots 114, 116 when the lower cable cover 52b is positioned over the lower cable support 64. With the HV cables 36, 38 disposed between lower cable support 64 and lower cable cover 52b, the lower cable cover 52b is secured to the lower cable support 64 by inserting a fastener 128 (e.g., a tie fastener) through the aligned slots 114, 124 and 116, 126.

With reference now to FIG. 1, one example assembly operation of the HV cable bundle router assembly 18 is described in more detail. Initially, the HV cable bundle router 20, first HV cable bundle 22, and second HV cable bundle 24 are provided. With the lower cable covers 52b removed, the HV cables 36, 38 are respectively seated within the first and second cable receiving surfaces 110, 112 of each lower cable support 64. One lower cable cover 52b is then placed over each lower cable support 64 such that HV cable 36 is enclosed between cable receiving surfaces 110, 120 and HV cable 38 is enclosed between cable receiving surfaces 112 and 122. In this position, outboard slots 114 and 124 are aligned, and outboard slots 116 and 126 are aligned. A fastener, such as the illustrated tie fastener 128, is then inserted through the aligned apertures 114, 124 and 116, 126 and fastened to secure the lower cable cover 52b to the lower cable support 64. This sub-assembly may then be provided for a final assembly.

Next, as shown in FIG. 1, the upper cable covers 52a are arranged on the first HV cable bundle 22 such that HV cable 30 is disposed/seated within the rounded cable receiving surface 80, and the HV cable 32 is disposed/seated within the rounded cable receiving surface 82. In the example embodiment, the upper cable covers 52a are secured to the HV cables 30, 32 via one or more of fasteners 102 located within 100 of flange 94. This sub-assembly may then be provided for the final assembly.

In the final assembly, the surface 54 of base plate 50 is disposed against the IDCM 14 (or other suitable component) and secured thereto via fasteners inserted through apertures 58. It will be appreciated that base plate 50 may be attached to the IDCM 14 by alternative operations, such as welding. Next, the upper cable covers 52a, which are attached to the HV cables 30, 32, are subsequently coupled to the upper cable supports 62 by inserting fastener clip 86 into slot 72, intermediate tab 84 into intermediate slot 70, and fastener clip 88 into slot 74. The electrical connectors 34, 40 may then be plugged into receiving connectors (not shown) of HV components, such as the HV battery pack 12 and HV power distribution module 16.

During an example operation, such as a vehicle impact event, at least one of the HV components (e.g. HV battery pack 12) attached to the first HV cable bundle 22 is subjected to a displacement force. In some scenarios, this force causes tension on the HV cables 30, 32 that are being held in place by the HV cable bundle router 20, which could result in a large pull out force on the electrical connector 34 and cause damage thereto. However, as previously described, the first and/or second fastener clips 86, 88 are designed to break away or separate from the upper cable cover 52a under a predetermined force, such as from the vehicle impact.

In this way, the tension/pulling force on the HV cables 30, 32 is transferred to the upper cable cover 52a, the first fastener clip 86, and/or the second fastener clip 88. This transfer of force causes the first and/or second fastener clips 86, 88 to break away from the upper cable cover 52a, thereby causing the upper cable cover 52a to separate from the base plate 50 and allowing movement of the HV cables 30, 32 to prevent the pullout force on the electrical connector 34. Advantageously, the upper cable covers 52a remain secured to the HV cables 30, 32 via the fasteners 102 to prevent flying debris.

Described herein are systems and methods for preventing pullout forces on HV electrical connectors caused by vehicle impact loading. The system utilizes a HV cable bundle router with a break-away attachment that holds HV cables in place during normal operation. Under a predetermined force, one or more fastener clips holding the HV cables in place are designed to purposely break/separate, thereby allowing the HV cables to flex without causing damage to the HV cables or their electrical connectors.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. An impact releasable cable bundle router for a vehicle electrical system, comprising:
a base plate configured to couple to a vehicle component;
a cable support extending outwardly from the base plate and including a cable receiving surface configured to receive an electrical cable; and
a cable cover configured to couple to the cable support to secure the electrical cable therebetween,
wherein the cable cover includes a fastener clip to at least partially secure the cable cover to the cable support, and
wherein the fastener clip is configured to intentionally break away from the cable cover under a predetermined load from a vehicle impact event to thereby release the electrical cable and cable cover and facilitate preventing pull out loads on an electrical connector of the electrical cable.

2. The impact releasable cable bundle router of claim 1, wherein the cable receiving surface is a first rounded cable receiving surface configured to partially surround the electrical cable.

3. The impact releasable cable bundle router of claim 2, wherein the cable cover includes a second rounded cable receiving surface configured to align with the first rounded cable receiving surface to surround the electrical cable.

4. The impact releasable cable bundle router of claim 1, wherein the fastener clip is a first fastener clip, and the cable cover further includes:
an intermediate tab; and
a second fastener clip.

5. The impact releasable cable bundle router of claim 4, wherein the cable support comprises:
a first slot configured to receive the first fastener clip;
an intermediate slot configured to receive the intermediate tab; and
a second slot configured to receive the second fastener clip.

6. The impact releasable cable bundle router of claim 5, wherein the intermediate tab is disposed between the first and second fastener clips.

7. The impact releasable cable bundle router of claim 5, wherein the intermediate slot is disposed between the first and second slots.

8. The impact releasable cable bundle router of claim 7, wherein the cable receiving surface comprises:
a first cable receiving surface disposed between the first slot and the intermediate slot and configured to receive a first electrical cable; and
a second cable receiving surface disposed between the intermediate slot and the second slot and configured to receive a second electrical cable.

9. The impact releasable cable bundle router of claim 1, wherein the cable cover includes a semi-annular flange with a convex slot.

10. The impact releasable cable bundle router of claim 9, further comprising a tie strap disposed within the convex slot and extending about the electrical cable to secure the cable cover to the electrical cable to facilitate preventing separation therebetween when the cable cover is released from the cable support during the vehicle impact event.

11. A vehicle comprising:
an electric traction motor;
a high voltage (HV) battery configured to provide power to the electric motor;
a HV cable bundle including a HV cable electrically coupled to the HV battery; and
an impact releasable HV cable bundle router configured to support the HV cable bundle in a desired orientation, the HV cable bundle router including:
a base plate configured to couple to a vehicle component;
a cable support extending outwardly from the base plate and including a cable receiving surface configured to receive the HV cable; and
a cable cover configured to couple to the cable support to secure the HV cable therebetween,
wherein the cable cover includes a fastener clip to at least partially secure the cable cover to the cable support, and
and wherein the fastener clip is configured to intentionally break away from the cable cover under a predetermined load from a vehicle impact event to thereby release the HV cable and cable cover to facilitate preventing pull out loads on an electrical connector of the HV cable.

12. The vehicle of claim 11, wherein the cable receiving surface is a first rounded cable receiving surface configured to partially surround the HV cable.

13. The vehicle of claim 12, wherein the cable cover includes a second rounded cable receiving surface configured to align with the first rounded cable receiving surface to surround the HV cable.

14. The vehicle of claim 11, wherein the fastener clip is a first fastener clip, and the cable cover further includes:
an intermediate tab; and
a second fastener clip.

15. The vehicle of claim 14, wherein the cable support comprises:
a first slot configured to receive the first fastener clip;
an intermediate slot configured to receive the intermediate tab; and
a second slot configured to receive the second fastener clip.

16. The vehicle of claim 15, wherein the intermediate tab is disposed between the first and second fastener clips.

17. The vehicle of claim 15, wherein the intermediate slot is disposed between the first and second slots.

18. The vehicle of claim 17, wherein the HV cable includes a first HV cable and a second HV cable, and wherein the cable receiving surface comprises:
a first cable receiving surface disposed between the first slot and the intermediate slot and configured to receive a first HV cable; and
a second cable receiving surface disposed between the intermediate slot and the second slot and configured to receive a second HV cable.

19. The vehicle of claim 11, wherein the cable cover includes a semi-annular flange with a convex slot.

20. The vehicle of claim 19, further comprising a tie strap disposed within the convex slot and extending about the HV cable to secure the cable cover to the HV cable to facilitate preventing separation therebetween when the cable cover is released from the cable support during the vehicle impact event.
